(19) United States
(12) Patent Application Publication
(10) Pub. No.: US 2011/0141396 A1
(43) Pub. Date: Jun. 16, 2011

(54) ILLUMINATION DEVICE AND LIQUID CRYSTAL DISPLAY DEVICE

(75) Inventors: Mayumi Nakamura, Osaka-shi (JP); Yuhsaku AJjichi, Osaka-shi (JP)

(73) Assignee: SHARP KABUSHIKI KAISHA, Osaka-shi, Osaka (JP)

(21) Appl. No.: 13/058,199

(22) PCT Filed: Jun. 24, 2009
(86) PCT No.: PCT/JP2009/061516

§ 371 Date: Feb. 9, 2011

(30) Foreign Application Priority Data
Sep. 30, 2008 (JP) 2008-254399

(51) Int. Cl. G02F 1/13357; G02F 1/1335

(52) U.S. Cl. 349/62; 362/97.1

(57) ABSTRACT

A backlight (2) (illumination device) is provided with a plurality of light emitting units (11), each of which includes a light source (5), a light guide (7) which diffuses light emitted from the light source and emits light from a light emitting surface, and a reflecting sheet (6) which is disposed on the opposite side to the light emitting surface of the light guide and reflects light traveling in the light guide so that the reflected light is directed toward the light emitting surface. In the backlight (2), the light emitting units (11) are arranged in tandem. Each light emitting unit (11) is also provided with a substrate (4) on which the light source (5) is fixed. The light guide (7) is provided with a projection (12) on the surface facing the reflecting sheet (6). Each of the reflecting sheet (6) and the substrate (14) is provided with a hole (14) or a through hole (13) (a hole or a recess) in which the projection (12) fits.

### TECHNICAL FIELD

The present invention relates to an illumination device utilized for a backlight and the like of a liquid crystal display device and a liquid crystal display device including the illumination device.

### BACKGROUND ART

In recent years, liquid crystal display devices are rapidly spreading in place of cathode-ray tube (CRT) display devices. Features of the liquid crystal display devices are, for example, that they are energy saving, thin, and light-weight. As such, the liquid crystal display devices are widely used for a flat-panel television, a monitor, a cellular phone, and the like. One way to take further advantage of these features is to improve an illumination device which is disposed behind the liquid crystal display device.

The illumination devices are roughly classified into direct type illumination devices and edge light type illumination devices. In a direct type illumination device, a plurality of linear light sources such as cold cathode fluorescent tubes and hot cathode fluorescent tubes or point light sources such as light emitting diodes are located in parallel with each other behind a liquid crystal panel. Light emitted from the light sources illuminates the liquid crystal panel directly. This configuration allows the direct type illumination device to easily obtain high luminance even with a large screen. On this account, the direct type illumination device is mainly employed as a backlight for a large-screen liquid crystal display having a size of 20 inches and greater.

On the other hand, an edge light type illumination device includes a light guide provided behind the liquid crystal panel. Further, the edge light type illumination device has light sources provided at its side ends. Light emitted from the light sources is reflected by the light guide and illuminates the liquid crystal panel indirectly. A positional relationship between the light sources and the light guide is determined by positioning depending on a shape of a housing. In a case of a recent illumination device intended for a cellular phone, in particular, the positional relationship between the light sources and the light guide is sometimes determined by, in addition to the positioning depending on the shape of the housing, positioning by use of a double face adhesive tape. With these configurations, the edge light type illumination device can be made thinner, whereas its luminance is low. As such, the edge light type illumination device is mainly used as a backlight for a small-to-medium-sized display such as a cellular phone and a notebook computer.

Against such a background, in these years, a tandem type illumination device, in which a plurality of light guides are arranged so as to overlap each other behind the liquid crystal panel, has been disclosed (see Patent Literature 1, for example). This configuration makes it possible to obtain an illumination device that can realize both (i) high luminance and a large size that are advantages of the direct type illumination device and (ii) a thin body that is an advantage of the edge light type illumination device.

### CITATION LIST

### Patent Literature

### Patent Literature 1

Japanese Patent Application Publication Tokukai No. 2001-312916 A (Publication date: Nov. 9, 2001)

### Patent Literature 2

Japanese Patent Application Publication Tokukai No. 2006-301518 A (Publication date: Nov. 2, 2006)

### Patent Literature 3

Japanese Patent Application Publication Tokukai No. 2002-318386 A (Publication date: Oct. 31, 2002)

### SUMMARY OF INVENTION

### Technical Problem

In the tandem type illumination device, the positional relationship between the light sources and the light guide as well as positions of individual components including a reflecting sheet greatly influence brightness of the illumination device. For example, in a case where the light sources and the light guide are located very close to each other, light incident efficiency to the light guide is increased, thereby obtaining an illumination device with high light use efficiency. On the other hand, in a case where the light sources and the light guide are located at some distance from each other, the light incident efficiency to the light guide is decreased, which causes a problem that the brightness of the illumination device is reduced. This problem becomes more prominent as the distance between the light sources and the light guide increases.

Further, if the reflecting sheet is located out of position with respect to the light guide and the light sources, a light emitting state is altered from that in a case where the reflecting sheet is located in a normal position. This results in unevenness of luminance.

Patent Literature 2 discloses a configuration in which the light guide and the reflecting sheet are combined by providing a concave portion in one of the light guide and the reflecting sheet and a convex portion in the other or by screwing the light guide and the reflecting sheet to each other (see paragraph of Patent Literature 2).

However, the illumination device of Patent Literature 2 has rod-like light sources and does not have the tandem type configuration. As such, an accuracy of the positioning of the three components, i.e., the light source, the light guide, and the reflecting sheet, is not necessarily required to be as high as that in the tandem type configuration. On this account, Patent Literature 2 does not make any suggestions for accurate positioning of the three components, i.e., the light source, the light guide, and the reflecting sheet.

Meanwhile, in a case of the tandem type illumination device, a large-sized illumination device is obtained by arranging a plurality of light guide units, each of which is made up of a combination of the light source and the light guide, so as to overlap each other in parallel. Therefore, if the plurality of light guide units have different positional relationships between the light source and the light guide, the plurality of light guide units have different brightness. This causes a problem that the illumination device has a very poor uniformity of luminance.

The present invention has been achieved in view of the above problems, and an object of the present invention is to realize an illumination device with an improved uniformity of luminance by devising, in a tandem type illumination device, a method of fixing a light source, a light guide, and a reflecting sheet so that these components are accurately positioned.

### Solution to Problem

In order to achieve the above object, an illumination device according to the present invention includes a plurality of light emitting units, each of which including: a light source; a light guide which diffuses light from the light source and emits light from a light emitting surface; and a reflecting sheet which is disposed on an opposite side to the light emitting surface of the light guide and reflects light traveling in the light guide so that the reflected light is directed toward the light emitting surface. The light guide has: a light emitting section with a light emitting surface; and a light guiding section guiding the light from the light source to the light emitting section, and the plurality of light emitting units are arranged in such a manner that the light emitting section of each light guide is disposed so as to be on top of the light guiding section of a light guide adjoining to this light guide. The illumination device further includes a substrate on which the light source is fixed, and in the illumination device, the light guide is provided with at least one projection on a surface facing the reflecting sheet, and each of the reflecting sheet and the substrate is provided with at least one hole or recess in which the projection fits.

The illumination device of the present invention is a so-called tandem type illumination device. In the tandem type illumination device, the light source is fixed on the substrate, and the projection for positioning is provided on a surface of the light guide which surface faces the reflecting sheet (which surface is also referred to as a rear surface of the light guide). Further, each of the reflecting sheet and the substrate has the hole or the recess in which the projection of the light guide fits.

This configuration allows accurate positioning of the reflecting sheet and the light guide on the substrate on which the light source is located. Therefore, for example, highly accurate positioning of the components in such positions that optimal luminous efficiency is obtained, can achieves an illumination device having high luminous efficiency. Moreover, it is possible to equalize positional relationships of the light sources, the light guides, and the reflecting sheets among a plurality of light emitting units. In consequence, light emitting states of the respective light emitting units can be equalized, thereby improving the uniformity of luminance of the illumination device.

In the illumination device of the present invention, the substrate may be provided with respect to the plurality of light emitting units. In other words, a plurality of light emitting units may be arranged on one substrate.

In a configuration in which one substrate is provided with respect to one light emitting unit, it is necessary to perform positioning of each of a plurality of substrates. As a result, the light guides are more likely to be located out of position, which increases likelihood that unevenness of luminance occurs. In addition, since each of the light guides requires a substrate, the number of components increases as well.

On the other hand, the above-described configuration allows positioning of a plurality of light emitting units with respect to one substrate. As such, it is possible to prevent the light emitting units from being located out of position relative to each other. This can further improve the uniformity of luminance of the illumination device. Moreover, with the above-described configuration, the number of the substrates can be decreased, which leads to cost reduction.

In the illumination device of the present invention, the at least one projection may be provided in the light guiding section of the light guide.

The light that travels in the light guide is under no small influence of the projection. If the projection is provided in the light emitting section of the light guide, the light emitting state in the vicinities of the projection differs from the other parts. This results in unevenness of luminance.

With the above configuration, since the projection is provided in the light guiding section, the light emitted from the light guide is less influenced by the projection. The light emitting state of the light emitting section can thus be equalized.

In a case where the projection is provided in the light emitting section, the projection may become an obstacle in arranging a plurality of light guides so as to overlap each other, preventing appropriate positioning of each of the plurality of light guides. However, with the above configuration, the light guides can be appropriately positioned on the substrate.

In the illumination device of the present invention, the at least one projection may be provided in the light guide in such a manner as to be in a position closer to a side end than a center of the light guide.

An amount of light that travels in the light guide is more in the center than in the side end of the light guide. According to the above configuration, since the projection is provided in the position close to the side end of the light guide, it is possible to reduce influence of the projection on the light that travels in the light guide.

In the illumination device of the present invention, the at least one projection may include a plurality of projections and the at least one hole or recess may include a plurality of holes or recesses.

This configuration allows more accurate positioning of the light source, the light guide, and the reflecting sheet.

In the illumination device of the present invention, the light guide may be provided with a hole in which the light source fixed on the substrate fits.

This configuration allows accurate positioning of the light guide and the light source.

In the illumination device according to the present invention, mirror surface coating may be performed on other surfaces than the light emitting surface of the light guide.

With this configuration, the mirror surface coating performed on the other surfaces than the light emitting surface of the light guide makes it possible to decrease leakage of the light from the other surfaces than the light emitting surface. As such, luminous efficiency of the light emitting unit can be improved.

A liquid crystal display device of the present invention includes any of the foregoing illumination devices as a backlight.

With this configuration, including the illumination device of the present invention makes it possible to realize a liquid crystal display device with an excellent uniformity of luminance.

### ADVANTAGEOUS EFFECTS OF INVENTION

In the illumination device of the present invention, a plurality of the light guides configure a plurality of light emitting units respectively, and each light guide has a light emitting section with a light emitting surface and a light guiding section guiding the light from the light source to the light emitting section, and the plurality of light emitting units are arranged in such a manner that the light emitting section of each light guide is disposed so as to be on top of the light guiding section of a light guide adjoining to this light guide. The illumination device further includes a substrate on which the light source is fixed, and in the illumination device, the light guide is provided with at least one projection on a surface facing the reflecting sheet, and each of the reflecting sheet and the substrate is provided with at least one hole or recess in which the projection fits.

Therefore, it is possible to perform accurate positioning of the light source, the light guide, and the reflecting sheet, thereby realizing an illumination device with improved uniformity of luminance.

Further, the liquid crystal display device of the present invention includes the illumination device of the present invention as a backlight. This allows an improvement of the uniformity of luminance.

The other objects, features, and advantages of the present invention will be fully understood from the following description. The benefits of the present invention will become apparent from the following explanation with reference to the accompanying drawings.

### BRIEF DESCRIPTION OF DRAWINGS

FIG. 1 is a side view illustrating a partial configuration of a backlight provided in a liquid crystal display device shown in FIG. 2.

FIG. 2 is a cross sectional view illustrating a configuration of a liquid crystal display device according to an embodiment of the present invention.

FIG. 3 is a plane view illustrating a partial configuration of the backlight provided in the liquid crystal display device shown in FIG. 2.

FIG. 4 (a) of FIG. 4 is a plane view illustrating a configuration of a light guide provided in the backlight shown in FIG. 1, and (b) of FIG. 4 is a side view illustrating a configuration of the light guide provided in the backlight shown in FIG. 1.

FIG. 5 is a plane view illustrating a configuration of a reflecting sheet provided in the backlight shown in FIG. 1.

FIG. 6 (a) of FIG. 6 is a plane view illustrating a partial configuration of a substrate provided in the backlight shown in FIG. 1, and (b) of FIG. 6 is a side view illustrating a partial configuration of the substrate provided in the backlight shown in FIG. 1.

FIG. 7 (a) to (c) of FIG. 7 are cross sectional views illustrating shapes of projections. Note that each of these figures illustrates a cross section of the light guide taken along the line A-A′ of (a) of FIG. 4.

FIG. 8 is a side view illustrating another configuration example of the backlight provided in the liquid crystal display device of the present invention.

### DESCRIPTION OF EMBODIMENTS

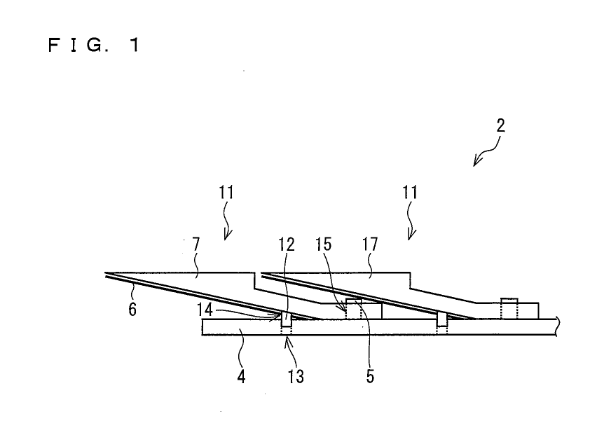

The following describes an embodiment of the present invention with reference to FIGS. 1 to 8. Note that the present invention is not limited to this embodiment.

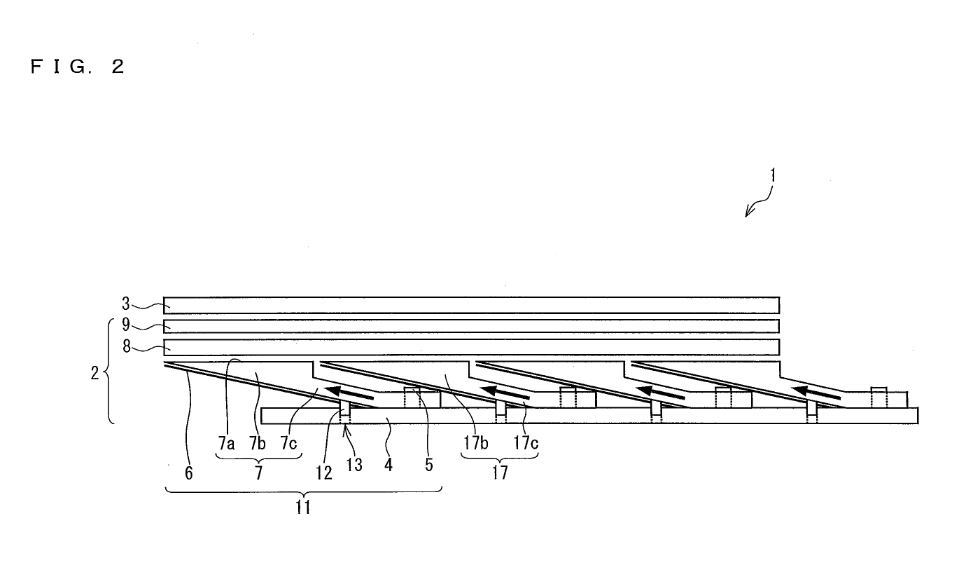

The present embodiment describes a tandem type illumination device having a plurality of light-emitting units each configured by a combination of a point light source and a light guide. FIG. 2 illustrates a configuration of a liquid crystal display device 1 including the tandem type illumination device as a backlight.

The liquid crystal display device 1 includes a backlight 2 (illumination device) and a liquid crystal display panel 3 that is disposed to face the backlight 2.

The liquid crystal display panel 3 is of the same kind as a common liquid crystal display panel used for a conventional liquid crystal display device. Although not illustrated, the liquid crystal display panel 3 is made up of, for example, an active matrix substrate on which a plurality of TFTs (Thin Film Transistors) are formed, a CF substrate facing the active matrix substrate, and a liquid crystal layer sealed with a seal material between these substrates.

The following elaborates a configuration of the backlight 2 included in the liquid crystal display device 1.

As illustrated in FIG. 2, the backlight 2 is located on a rear surface (on an opposite side to a display surface) of the liquid crystal display panel 3. The backlight 2 includes, as illustrated in FIG. 2, a plurality of light emitting units 11, a diffusing plate 8, and an optical sheet 9. For convenience of explanation, the present embodiment describes one light emitting unit 11 having a light guide 7 and another light emitting unit 11 having a light guide 17 by way of example. Unless otherwise noted, the light guide 7 represents both the light guides 7 and 17.

One light emitting unit 11 includes: a light source 5; the light guide 7 which diffuses and surface emits light from the light source 5; a substrate 4 on which the light source 5 is disposed; a reflecting sheet 6; and other components. The light guide 7 has: a light emitting section 7b with a light emitting surface 7a; and a light guiding section 7c which guides the light from the light source 5 to the light emitting section 7b. The light emitting section 7b and the light guiding section 7c are different in thickness at least at a connection therebetween. Further, the light guide 7 is arranged in such a manner that a light emitting section 17b of another light guide 17 is disposed so as to be on top of the light guiding section 7c of the light guide 7. In consequence, a plurality of light guides 7, 17, . . . form a substantially flush light emitting surface (a light emitting surface of the entire backlight 2; a light emitting region). Such an arrangement is termed a tandem arrangement.

On a structure in which a plurality of light emitting units 11 are thus arranged in tandem, the diffusing plate 8 and the optical sheet 9 are disposed in this order, as illustrated in FIG. 2.

The diffusing plate 8 is provided to face the light emitting surfaces 7a of the light guides 7, 17, . . . so as to entirely cover the substantially flush light emitting surface (light emitting region) made up of the light emitting surfaces 7a. The diffusing plate 8 diffuses the light emitted from the light emitting surface 7a of the light guide 7 to illuminate the optical sheet 9.

The optical sheet 9 is made up of a plurality of sheets stacked on a front surface of the light guide 7. The light emitted from the light emitting surface 7a of the light guide 7 is equalized and collected by the optical sheet 9 to illuminate the liquid crystal display panel 3. In other words, as the optical sheet 9, for example, a diffusing sheet which collects and diffuses light, a lens sheet which collects light and improves the luminance in a front direction (a direction toward the liquid crystal display panel), and a polarized light reflecting sheet which improves luminance of the liquid crystal display device 1 by reflecting one of the polarized components of light and transmitting the other polarized component are applicable. These sheets are preferably used in appropriate combinations, depending on price and performance of the liquid crystal display device 1.

Note that the present embodiment is exemplified by a configuration in which the diffusing plate 8 is directly put on the light emitting surface 7a of the light guide 7. However, the present invention is not limited to such a configuration. In another configuration example, a transparent plate can be sandwiched between the light guide 7 and the diffusing plate 8. The transparent plate provided between the light guide 7 and the diffusing plate 8 allows keeping a certain distance between the light guide 7 and the diffusing plate 8, thereby diffusing light within the transparent plate. The transparent plate is made of a translucent material such as a polyethylene film.

With this configuration, the light emitted from the point light source 5 travels in the light guide 7, while being subjected to a scattering effect and a reflection effect, and goes out from the light emitting surface 7a.

The light emitted from the light emitting surface 7a is diffused by the diffusing sheet 8 and equalized and collected by the optical sheet 9 to illuminate the liquid crystal display panel 3.

FIG. 1 is a side view illustrating a partial configuration of the backlight 2 included in the liquid crystal display device 1 shown in FIG. 2. As the partial configuration of the backlight 2, FIG. 1 depicts two light emitting units 11 arranged in tandem.

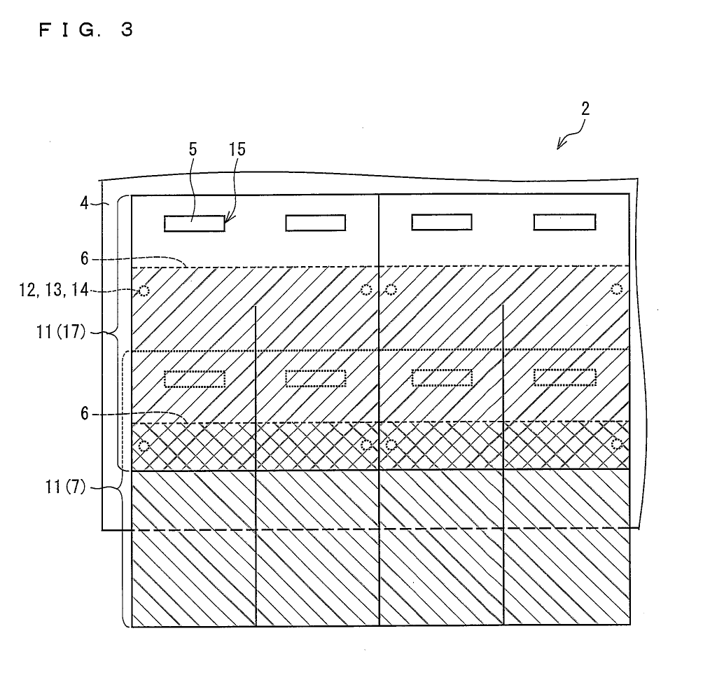

FIG. 3 is a plane view illustrating a partial configuration of the backlight 2 provided in the liquid crystal display device 1 shown in FIG. 2. As illustrated in FIG. 3, the backlight 2 is made up of a plurality of light emitting units 11 that are arranged vertically and horizontally. The partial configuration of the backlight 2 depicted in FIG. 3 includes four light emitting units arranged in a two by two array. In FIG. 3, the reflecting sheets 6 are hatched. Here, the reflecting sheets 6 to be used in combination with one light guides 7 and the reflecting sheets 6 to be used in combination with another light guides 17 are differently hatched.

Note that the diffusing plate 8 and the optical sheet 9 are not shown in FIGS. 1 and 3.

As illustrated in FIG. 1, a projection 12 is provided on a rear surface (a surface facing the reflecting sheet 6) of the light guide 7. The reflecting sheet 6 has, in a position corresponding to the projection 12, a hole (an opening) 14 in which the projection 12 fits. Further, the substrate 4 has, in a position corresponding to the projection 12 and the hole 14, a through hole (an opening) 13 in which the projection 12 fits.

In the light emitting unit 11 of the present embodiment, as described above, the light source 5 is fixedly provided on the substrate 4. Further, the opening 14 and the through hole 13, in which the projection 12 of the light guide 7 fits, are provided in the reflecting sheet 6 and the substrate 4, respectively. This configuration allows accurate positioning of the reflecting sheet 6 and the light guide 7 on the substrate 4 on which the light source 5 is provided. Therefore, it is possible to equalize positional relationships of the light sources 5, the light guides 7, and the reflecting sheets 6 in a plurality of light emitting units 11. The light emitting states of the light emitting units 11 can thus be equalized, thereby improving uniformity of luminance of the backlight 2.

Now, components configuring the backlight 2 are described.

The light source 5 is a point light source such as a light emitting diode (LED). In the present embodiment, the light source 5 is made up of a plurality of kinds of light emitting diodes each having a different emission color from others. Specifically, the light source 5 is made up of a group of LEDs in which a plurality of light emitting diodes each having one of three colors, i.e., red (R), green (G), and blue (B), are aligned. The configuration of the light source, in which these three colors of light emitting diodes are combined, makes it possible to emit white light at the light emitting surface. Note that, however, in the backlight of the present invention, the light source is not necessarily made up of a plurality of kinds of light emitting diodes each having a different emission color from others. For example, the light source may be configured by one kind of LEDs such as white LEDs.

The combination of the colors of the light emitting diodes can be properly determined based on coloring properties of the LEDs of the respective colors, coloring property of the backlight desirable for intended use of the liquid crystal display device 1, and the like. The light source 5 made up of the group of LEDs is mounted on the substrate 4. As the light source 5, a side-emitting LED in which LED chips of the respective colors are molded into a package may also be used. This makes it possible to obtain a backlight with a wide color reproduction range. The light source 5 thus configured is fixedly mounted on the substrate 4.

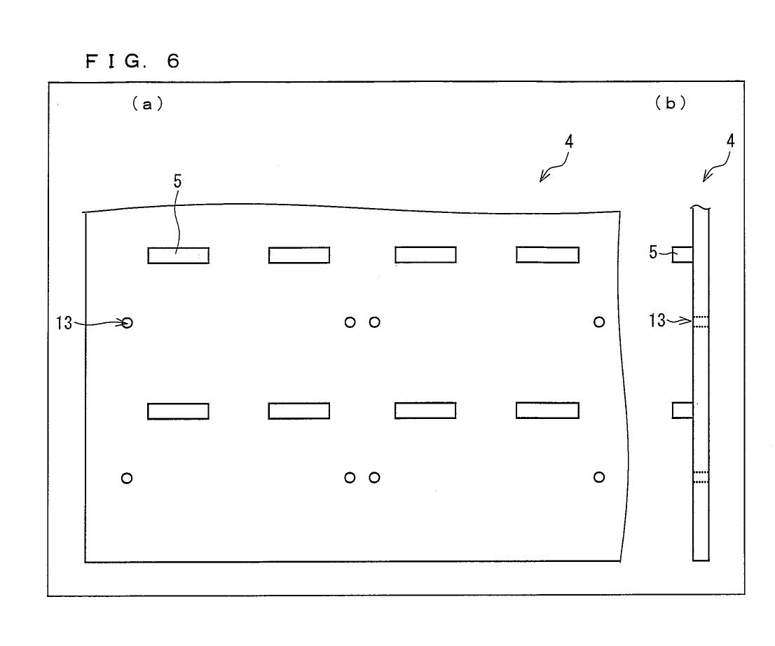

In FIG. 6, (a) and (b) illustrate a partial configuration of the substrate 4. (a) of FIG. 6 is a plane view of the substrate 4, and (b) of FIG. 6 is a side view of the substrate 4. As shown in these figures, the light sources 5 are mounted on the substrate 4. The substrate 4 is provided with the through holes 13 for positioning.

On the substrate 4, a driver (not illustrated) which controls turning on and off of the LEDs configuring the light source 5 is further mounted. Since the driver and the light sources 5 are mounted on one same substrate 4, the number of the substrates and the number of connectors and the like that connect the substrates can be reduced. Therefore, it is possible to reduce costs of the device. Moreover, reducing the number of the substrates allows the backlight 2 to be thinner.

As can be understood from FIGS. 2, 3 as well as (a) of FIG. 6 and the like, one substrate 4 is provided for a plurality of light emitting units 11. This configuration allows positioning of a plurality of light emitting units on one substrate. As such, relative positioning of the light emitting units 11 can be more accurately performed. In consequence, the luminance uniformity of the illumination device can further be improved. Further, this configuration also allows reducing the number of the substrates.

The light guides 7 performs surface emission of the light emitted from the light sources 5. The light emitting surface 7a is a surface for illuminating a target to be illuminated. In the present embodiment, the light guide 7 has a tandem configuration as illustrated in FIGS. 1 and 2. That is, the light guide 7 has: the light emitting section 7b with the light emitting surface 7a; and the light guiding section 7c which guides the light from the light source 5 to the light emitting section 7b. The light emitting section 7b and the light guiding section 7c are different in thickness at least at a connection therebetween. Further, the light guide 7 is arranged in such a manner that a light emitting section 17b of another light guide 17 is disposed so as to be on top of the light guiding section 7c of the light guide 7. In consequence, a plurality of light guides 7, 17, . . . form a substantially flush light emitting surface (a light emitting surface of the whole backlight 2; a light emitting region).

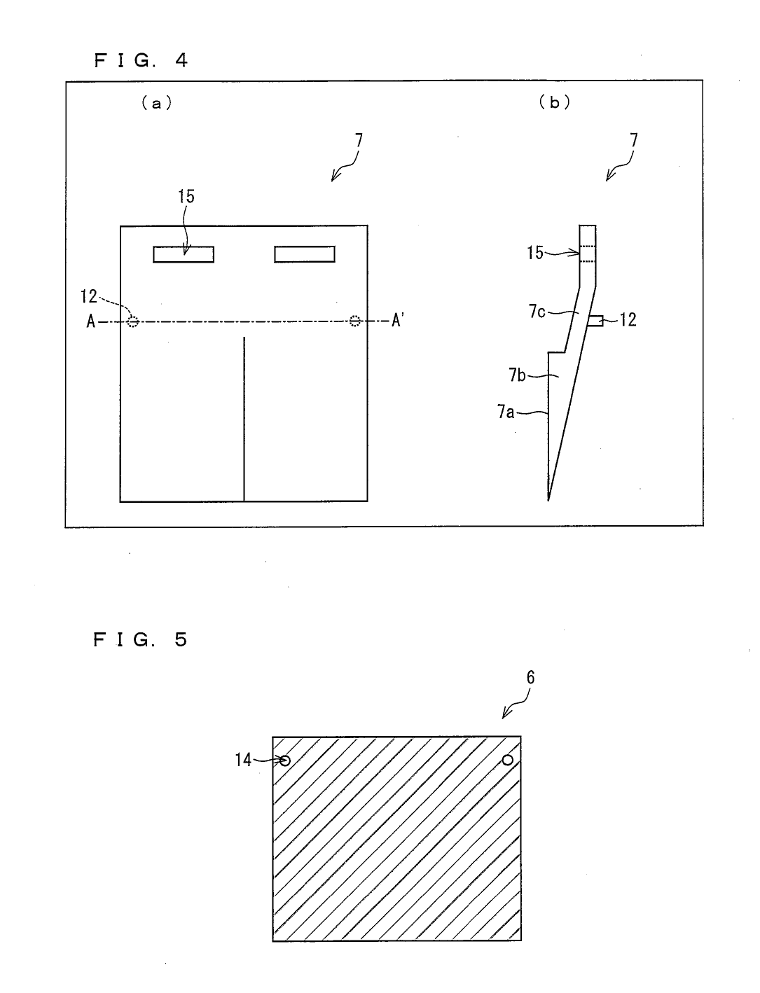

In FIG. 4, (a) shows a planar configuration of the light guide 7, and (b) shows a side view of the light guide 7. As shown in (a) and (b) of FIG. 4, in a vicinity of an end on a light guiding section 7c side of the light guide 7, two openings 15 are provided for disposing the light sources. Since the light guide 7 is thus provided with the openings 15 for disposing the light sources, if the light guide 7 is placed on the substrate 4 on which the light sources 5 are mounted, the light sources 5 can fit in the openings 15, as illustrated in FIG. 1. This makes accurate positioning of the light guide 7 and the light sources 5 possible.

On a rear surface (a surface opposite to the light emitting surface 7a) of the light guide 7, projections 12 are provided, as shown in (b) of FIG. 4. The projections 12 are provided in the light guiding section 7c of the light guide 7. As such, the light emitted from the light emitting surface 7a is less influenced by the projections 12, thereby equalizing the light emitting state of the light emitting surface 7a.

In a case where the projections are provided on a rear surface of the light emitting section of the light guide, the projections may become obstacles in arranging the light guides so as to overlap each other, preventing appropriate positioning of each of the light guides. In the configuration of the present embodiment, to the contrary, the projections 12 are provided on the rear surface of the light guiding section 7c of the light guide 7. As such, when a plurality of light guide 7 (17) are arranged in tandem so as to overlap, the projections 12 do not prevent the overlapping arrangement. The light guides 7 (17) are thus appropriately positioned on the substrate 4.

In (a) of FIG. 4, a dashed line indicates the positions where the projections 12 are to be provided. As illustrated in this figure, the projections 12 are provided in the vicinities of side ends of the light guide 7 (in other words, in positions closer to the side ends than to the center of the light guide 7). Since an amount of light that travels in the light guide 7 is more in the center than in the side ends of the light guide 7, if the projections 12 are provided in the positions close to the side ends of the light guide, it is possible to reduce influence of the projections 12 on the light that travels in the light guide.

As described above, it is preferable that regions in which an amount of the light from the light sources 5 is relatively small be selected as the positions where the projections 12 are provided. In a case where the light sources 5 are LED elements, the light from the LED elements enters into the light guide as a light flux having a certain cross section area, and the cross section area increases gradually as the light travels. On this account, it is more preferable that the projections 12 be provided in a region where the light flux is not sufficiently diffused to the both side ends of the light guide 7, i.e., at an edge of the light guiding section 7c of the light guide which edge is closer to the light sources 5.

The present embodiment describes a configuration in which one light guide 7 has two holes 15 for disposing the light sources by way of example. However, the present invention is not limited to this configuration. Further, the present embodiment describes a configuration in which the substrate 4 is provided with the through holes 13 for positioning the light guide 7 and the reflecting sheet 6 by way of example. However, the present invention is not limited to this configuration, and the substrate 4 may be provided with recesses as components for positioning.

Moreover, the present embodiment describes an example in which the reflecting sheet 6 is provided with the holes (openings) 14 in which the projections of the light guide 7 fit. However, the present invention is not limited to this example, and the reflecting sheet 6 may be provided with recesses in which the projections 12 fit. In a case where the reflecting sheet 6 is provided with the recesses, the projections 12 of the light guide 7 fit in the openings or the recesses provided in the substrate 4 for positioning, while being in contact with the recesses of the reflecting sheet 6. Therefore, the light that enters into the projections is also reflected by a function of the reflecting sheet.

The light guide 7 is mainly made of a transparent resin such as polycarbonate (PC) and polymethyl methacrylate (PMMA). However, there is no particular limitation, and it is preferable that a material with a high light transmissivity be used. The light guide 7 can be shaped by, for example, injection molding, extrusion molding, heat press molding, cutting, and the like. Note that, however, the shaping method is not limited to these and any method that shows the same property may be employed.

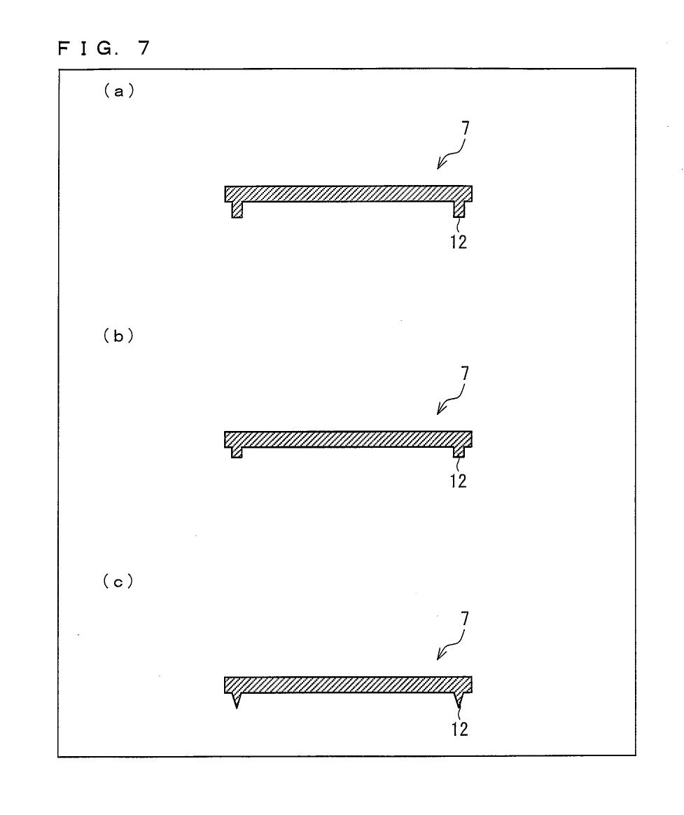

In FIG. 7, (a), (b), and (c) illustrate examples of cross sectional shapes of the projections 12. Each of these figures depicts a shape of the cross section of the light guide 7 taken along the line A-A′ in (a) of FIG. 4. The projections 12 shown in (a) and (b) of FIG. 7 have columnar shapes, and the projections 12 shown in (c) of FIG. 7 have conical shapes.

The columnar projections 12 shown in (a) of FIG. 7 are taller in comparison with the columnar projections 12 shown in (b) of FIG. 7. This allows the projections 12 to be hardly disengaged when fitted in the through holes 13 provided in the substrate 4.

In the meantime, due to tapered ends, the conical projections 12 shown in (c) of FIG. 7 have an advantage that, in comparison with the columnar projections 12, they are easier to fit in the through holes 13 provided in the substrate 4.

Note that the foregoing shapes of the projections 12 serve only as examples of the present invention, and the present invention is not limited to these examples.

FIG. 5 illustrates a planar configuration of the reflecting sheet 6. As illustrated in this figure, the reflecting sheet 6 has the holes 14 in positions corresponding to the projections 12 provided in the light guide 7.

The reflecting sheet 6 is disposed so as to be in contact with the rear surface (a surface facing the light emitting surface 7a) of the light guide 7. The reflecting sheet 6 reflects light so that a greater amount of light is emitted from the light emitting surface 7a. In the present embodiment, a plurality of light guides 7 are provided, and each of the light guides 7, 17, . . . is provided with the reflecting sheet 6.

Meanwhile, Patent Literature 3 discloses a technique in which a pin formed on a light guide plate runs through openings provided in a diffusing sheet, a brightness enhancing sheet, and the like so as to fix the light guide plate and these sheets to each other. However, Patent Literature 3 does not disclose how the light source and the light guide plate are positioned.

In the foregoing configuration of the present embodiment, on the other hand, the projections 12 are provided on the rear surface of the light guide 7. Corresponding to the positions of the projections 12, the holes 14 in which the projections 12 fit are provided in the reflecting sheet 6. In addition, the through holes 13 in which the projections 12 fit are provided in the substrate 4 on which the light sources 5 are fixedly arranged.

The components (the projections 12, the through holes 13, and the holes 14) for positioning are positioned in such a manner that the light guide 7, the reflecting sheet 6, and the substrate 4 are located in a desired positional relationship. As such, the configuration of the present embodiment makes it possible to locate the light guides 7, the reflecting sheet 6, and the substrate 4 on which the light source 5 are provided by accurate positioning. This allows the respective components to be securely located in desired positions. Further, this can reduce unevenness in the positional relationship of the components among the light emitting units 11. As a result, the uniformity of luminance of the backlight 2 can be improved.

Moreover, as shown in FIG. 3, one light emitting unit 11 is provided with two projections 12, two through holes 13, and two holes 14. Since the number of each of the individual components for positioning is plural, they can be more accurately positioned.

The present embodiment is exemplified by a configuration in which two projections 12, two through holes 13, and two holes 14 are provided. However, the number of each of the individual components may be three or more. In a case where three projections, three through holes, and three holes are provided, for example, one of the three projections provided in the light guide is preferably located close to an edge of the light emitting section of the light guide. This can prevent a decrease in luminance caused by a suspension of the light guide from the substrate and the reflecting sheet.

Note that it is preferable that the number of the projections be controlled so that the projections do not block traveling of the light in the light guide.

In the light guide, the light is guided by use of total reflection properties of light. As such, providing a number of projections causes the total reflection condition of light to be dissatisfied, resulting in leakage of the light from the light guide. This may cause a decrease in luminance. On this account, in a case where a number of projections are provided, other surfaces than the light emitting surface of the light guide are coated so that no leakage of light occurs. This can curb the decrease in luminance efficiency caused by the provision of the projections. In order to prevent the light from leaking, for example, mirror surface coating is performed. The mirror surface coating is a process in which a prescribed coating agent is applied on a surface so as to give the surface a mirror finish. Performing the mirror surface coating on the surfaces other than the light emitting surface makes it possible to decrease the leakage of the light from the other surfaces than the light emitting surface, thereby improving luminous efficiency.

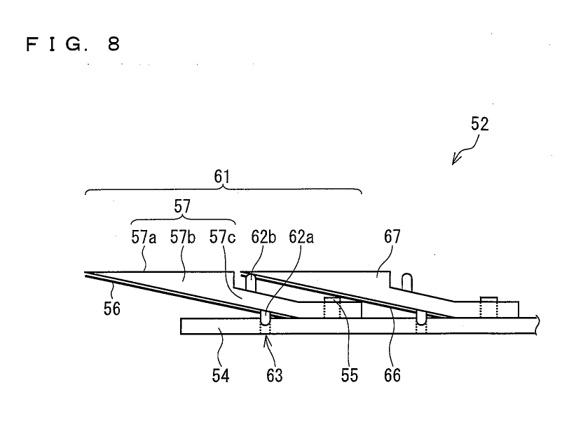

Another configuration example of a backlight according to the present invention is shown in FIG. 8. FIG. 8 is a side view illustrating a partial configuration of the backlight 52 included in the liquid crystal display device of the present invention. As the partial configuration of the backlight 2, FIG. 8 depicts two light emitting units 61 arranged in tandem. Although not illustrated in FIG. 8, a diffusing plate 8 and an optical sheet 9 are provided in the backlight 52, as in the backlight 2.

The backlight 52 illustrated in FIG. 8 includes a plurality of light emitting units 61. For convenience of explanation, here are described one light emitting unit 61 having a light guide 57 and another light emitting unit 61 having a light guide 67 by way of example. Unless otherwise noted, the light guide 57 represents both the light guides 57 and 67.

One light emitting unit 61 includes: a light source 55, the light guide 57 which diffuses and surface emits light from the light source 55; a substrate 54 on which the light source 55 is disposed; a reflecting sheet 56; and other components. The light guide 57 has: a light emitting section 57b with a light emitting surface 57a; and a light guiding section 57c which guides the light from the light source 55 to the light emitting section 57b. The light emitting section 57b and the light guiding section 57c are different in thickness at least at a connection therebetween. Further, the light guide 57 is arranged in such a manner that a light emitting section of another light guide 67 is disposed so as to be on top of the light guiding section 57c of the light guide 57. In consequence, a plurality of light guides 57, 67, . . . form a substantially flush light emitting surface (a light emitting surface of the entire backlight 52; a light emitting region).

As illustrated in FIG. 8, a projection 62a is provided on a rear surface (a surface facing the reflecting sheet 56) of the light guide 57. The reflecting sheet 56 has, in a position corresponding to the projection 62a, a hole (an opening) in which the projection 12 fits. Further, the substrate 54 has, in a position corresponding to the projection 62a and the hole of the reflecting sheet 56, a through hole (an opening) 63 in which the projection 62a fits.

The above configuration is approximately the same as the configuration of the aforementioned backlight 2. In the meantime, unlike the backlight 2, the backlight 52 is provided with another projection 62b on a top surface of the light guiding section 57c of the light guide 57 (a surface of the light guide 57 which is opposite to the rear surface of the light guide and is on the same side as the light emitting surface 57a). The projection 62b fits in a hole provided in the reflecting sheet 66 located on a rear surface of the another light guide 67 which is disposed so as to be on top of the light guiding section 57c of the light guide 57. Apart from the hole in which the projection 62a fits, the reflecting sheet 66 has, in a position corresponding to the projection 62b, a hole in which the projection 62b fits.

With the above configuration, it is possible to more reliably prevent the reflecting sheet from being located out of position.

The present invention is not limited to the description of the embodiments above, but may be altered within the scope of the claims. An embodiment based on a proper combination of technical means disclosed in different embodiments is encompassed in the technical scope of the present invention.

### INDUSTRIAL APPLICABILITY

The present invention realizes an illumination device with improved luminance uniformity. The illumination device of the present invention can be used as a backlight of a liquid crystal display device.

### REFERENCE SIGNS LIST

1 Liquid Crystal Display Device
2 Backlight (Illumination Device)
3 Liquid Crystal Display Panel
4 Substrate
5 Light Source
6 Reflecting Sheet
17 Light Guide
17 Light Guide
7a Light Emitting Surface
7b Light Emitting Section
7c Light Guiding Section
   11 Light Emitting Unit
12 Projection
13 Through Hole (Opening or Recess)
14 Hole (Opening)
52 Backlight (Illumination Device)
54 Substrate
55 Light Source
56 Reflecting Sheet
57 Light Guide
67 Light Guide
57a Light Emitting Surface
57b Light Emitting Section
57c Light Guiding Section
61 Light Emitting Unit
62a Projection
62b Projection
63 Through Hole (Opening or Recess)
66 Reflecting Sheet

1. An illumination device comprising a plurality of light emitting units,
each of the plurality of light emitting units including:
a light source;
a light guide which diffuses light from the light source and emits light from a light emitting surface; and
a reflecting sheet which is disposed on an opposite side to the light emitting surface of the light guide and reflects light traveling in the light guide so that the reflected light is directed toward the light emitting surface,
the light guide having: a light emitting section with a light emitting surface; and a light guiding section guiding the light from the light source to the light emitting section, and
the plurality of light emitting units being arranged in such a manner that the light emitting section of each light guide is disposed so as to be on top of the light guiding section of a light guide adjoining to this light guide,
the illumination device further comprising a substrate on which the light source is fixed,
the light guide being provided with at least one projection on a surface facing the reflecting sheet, and
each of the reflecting sheet and the substrate being provided with at least one hole or recess in which the projection fits.

2. The illumination device according to claim 1, wherein
the substrate is provided with respect to the plurality of light emitting units.

3. The illumination device according to claim 1, wherein
the at least one projection is provided in the light guiding section of the light guide.

4. The illumination device according to claim 1, wherein
the at least one projection is provided in the light guide in such a manner as to be in a position closer to a side end than a center of the light guide.

5. The illumination device according to claim 1, wherein
the at least one projection includes a plurality of projections and the at least one hole or recess includes a plurality of holes or recesses.

6. The illumination device according to claim 1, wherein
the light guide is provided with a hole in which the light source fixed on the substrate fits.

7. The illumination device according to claim 1, wherein mirror surface coating is performed on other surfaces than the light emitting surface of the light guide.

8. A liquid crystal display device comprising an illumination device according to claim 1 as a backlight.
